(19) United States
(12) Patent Application Publication
(10) Pub. No.: US 2014/0163177 A1
(43) Pub. Date: Jun. 12, 2014

(54) PRESSURE SENSITIVE ADHESIVE AND METHOD OF SYNTHESIZING POLYMER USED FOR THE SAME

(71) Applicant: Hon Hai Precision Industry Co., Ltd., New Taipei (TW)

(72) Inventors: PEI-RONG SHIEH, New Taipei (TW); CHANG-CHIN WU, New Taipei (TW)

(73) Assignee: HON HAI PRECISION INDUSTRY CO., LTD., New Taipei (TW)

(21) Appl. No.: 14/100,011

(22) Filed: Dec. 8, 2013

(30) Foreign Application Priority Data
Dec. 11, 2012 (TW) 101146544

(51) Int. Cl. C09J 133/02

(52) U.S. Cl. CPC C09J 133/02
USPC 525/329.9; 525/329.7; 525/342

(57) ABSTRACT

A method of synthesizing an acrylic polymer used for a pressure sensitive adhesive includes steps as follows: polymerizing one or more acrylic monomers in the presence of a first initiator to obtain an acrylic prepolymer; and polymerizing the acrylic prepolymer and one or more silane coupling agents in the presence of a second initiator to obtain the acrylic polymer.

### BACKGROUND

1. Technical Field

The present disclosure relates to pressure sensitive adhesives, and particularly to a pressure sensitive adhesive having good heat resistance and a method of synthesizing an acrylic polymer used for the pressure sensitive adhesive.

2. Description of the Related Art

Currently, there are many types of pressure sensitive adhesives, such as rubber adhesive, silicon-gel adhesive, and acrylic adhesive. The rubber adhesive has a lower cost, but of poor heat resistance and ages quickly. The silicon-gel-typed adhesive has good heat resistance from a temperature range of minus 40 degrees Celsius to 300 degrees Celsius, but at a higher cost. The acrylic-typed adhesive has lower cost, but not so good heat resistance from a temperature range of minus 10 degrees Celsius to 180 degrees Celsius. When an operating temperature is higher than 180 degrees Celsius, the application of the acrylic-typed adhesive is limited.

Therefore, there is room for improvement within the art.

### BRIEF DESCRIPTION OF THE DRAWINGS

FIG. 1 shows one embodiment of a general molecular formula of an acrylic polymer.

FIG. 2 shows one embodiment of a general molecular formula of an acrylic prepolymer.

FIG. 3 shows one embodiment of a general molecular formula of a silane coupling agent.

FIG. 4 shows one embodiment of a general molecular formula of an acrylic monomer.

FIG. 5 shows a flowchart of one embodiment of a method of synthesizing the acrylic polymer of FIG. 1.

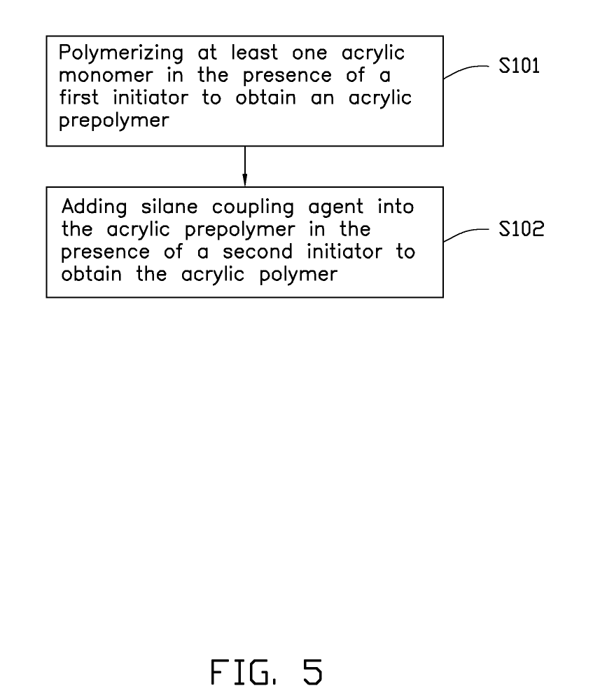

### DETAILED DESCRIPTION

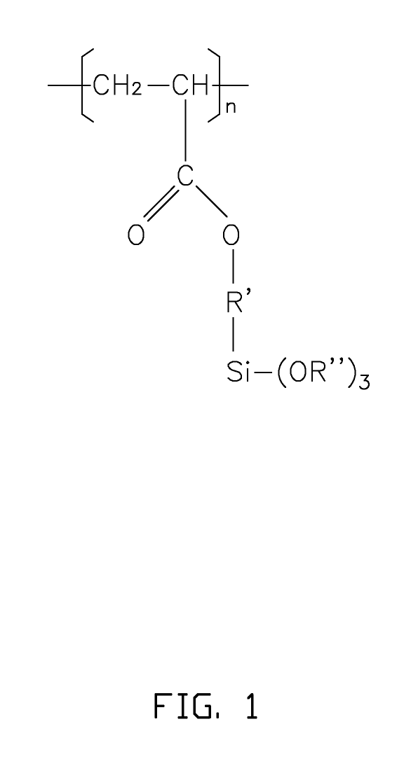

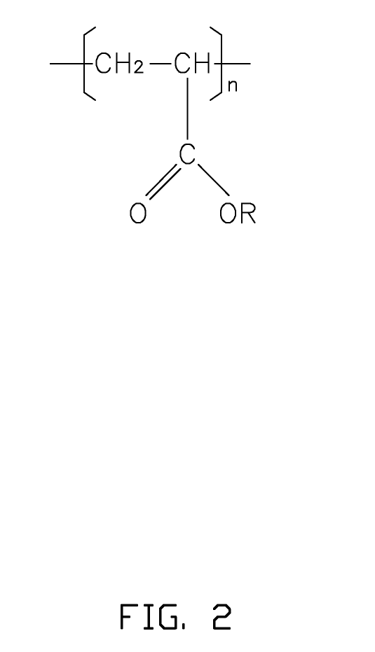

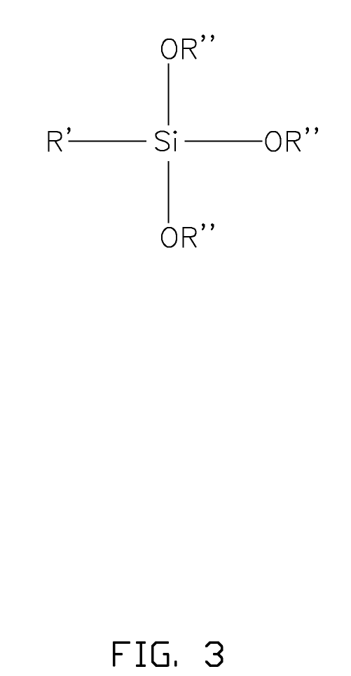

One embodiment of a pressure sensitive adhesive includes an acrylic polymer represented by a first formula (1) shown in FIG. 1. The acrylic polymer of the one embodiment is obtained by polymerizing an acrylic prepolymer represented by a second formula (2) shown in FIG. 2 and a silane coupling agent represented by a third formula (3) shown in FIG. 3. In FIG. 1, R′ can be selected from a group consisting of vinyl group, epoxy group, methacrylic acid, amino group, thiol group, and isocyanic acid, and R″ can be alkyl group or carboxylic group. In FIG. 2, R can be hydrogen atom, alkyl group, or amino group, and n is an integer. In FIG. 3, R′ can be selected from the group consisting of ethenyl group, epoxy group, methacrylic acid, amino group, thiol group, and isocyanic acid, and R″ can be alkyl group or carboxylic group.

One embodiment of a method of synthesizing the acrylic polymer used in the pressure sensitive adhesive of the one embodiment is illustrated as follows.

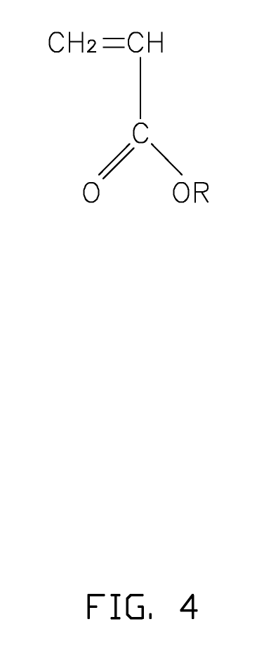

In step S101, one or more acrylic monomers are polymerized in the presence of a first initiator to obtain an acrylic prepolymer. The acrylic monomer can be represented by a fourth formula (4) shown in FIG. 4. The acrylic prepolymer can be represented by the first formula shown in FIG. 1.

In step S102, one or more silane coupling agents and an alcohol are added into the acrylic prepolymer in the presence of a second initiator, such that the acrylic polymer is obtained by a substitution reaction performed between the acrylic prepolymer and the one or more silane coupling agents. The one or more silane coupling agents can be represented by the third formula shown in FIG. 3. The acrylic polymer can be represented by the first formula shown in FIG. 1.

In the step S102, a weight ratio of the silane coupling agents to the acrylic prepolymer is in a range of about 1:100 to about 10:100. A weight ratio of the second initiator to the acrylic prepolymer is in a range of about 0.1:100 to about 1.0:100. A weight ratio of the alcohol to the acrylic prepolymer is in a range of about 5:100 to about 10:100. In the illustrated embodiment, the weight ratio of the silane coupling agents to the acrylic prepolymer is in a range of about 5:100 to about 10:100.

The highest heat resistance temperature of the pressure sensitive adhesive which includes the acrylic polymer can be adjusted by the weight ratio of the silane coupling agents to the prepolymer. The higher the weight ratio of the silane coupling agents to the prepolymer, the higher the highest heat resistance temperature, and the higher the glass transition temperature (T_{g}) of the pressure sensitive adhesive. However, the pressure sensitive adhesive with a high T_{g} may have a poor usability. When the weight ratio of the silane coupling agents to the acrylic prepolymer is in a range of about 5:100 to about 10:100, the pressure sensitive adhesive may achieve a balance between the physical properties of the highest resistance temperature and the T_{g}, such that the pressure sensitive adhesive has a relatively-high highest heat resistance temperature and a suitable T_{g} which may not negatively affect the usability thereof. The T_{g} of the pressure sensitive adhesive can be adjusted by adjusting T_{g} of the acrylic prepolymer. When the T_{g} of the acrylic prepolymer is in a temperature range of about minus 20 degrees Celsius to about minus 50 degrees Celsius, the T_{g} of the pressure sensitive adhesive is suitable for use.

The second initiator can be benzoyl peroxide (BPO) or 2,2′ azobisisobutyronitrile (AIBN). The alcohol can be methyl alcohol, ethyl alcohol, or propyl alcohol. In other embodiments, the second initiator is not limited to be the above material compounds, and can be other initiators, as long as the second initiator is capable of promoting a substitution reaction between the silane coupling agent and the acrylic prepolymer. The alcohol can be other alcohol, as long as the alcohol is capable of prohibiting the hydrolytic condensation of the pressure sensitive adhesive to facilitate preserving or preservation of the pressure sensitive adhesive.

In use, after being solidified, the pressure sensitive adhesive forms a cross-linked network structure by hydrolytic condensation reaction, which improves the heat resistance thereof. Since the acrylic polymer can be easily obtained by adding the silane coupling agent when polymerizing the acrylic prepolymer, the synthesis method of the acrylic polymer is relatively easy and has a lower cost.

A method for synthesizing the acrylic polymer used in the pressure sensitive adhesive will become apparent from the following detailed examples:

### Synthesis Example 1

Butyl acrylate, 2-ethylhexyl acrylate, and acrylic acid are dissolved in methylbenzene and ethyl acetate in the presence of BPO, and the temperature is elevated to about 80 degrees Celsius, so that the acrylic prepolymer is obtained by polymerization. A volume ratio of methylbenzene to total of butyl acrylate, 2-ethylhexyl acrylate, and acrylic acid is about 1.5:1.0. A volume of ethyl acetate is substantially equal to a total volume of butyl acrylate, 2-ethylhexyl acrylate, and acrylic acid.

Vinyl trimethoxy silane, ethyl alcohol, and BPO are added into the acrylic prepolymer, and the temperature is elevated at from about 70 degrees Celsius to 170 degrees Celsius, so that the acrylic polymer is obtained. A weight ratio of the vinyl trimethoxy silane to acrylic prepolymer is about 5:100. A weight ratio of BPO to acrylic prepolymer is about 0.2:100.

The highest heat resistance temperature of the pressure sensitive adhesive of EXAMPLE 1 is improved to be a range about 210 degrees Celsius to about 220 degree Celsius. The heat tolerance time is improved to be a range about 24 hours to about 48 hours.

### Synthesis Example 2

Butyl acrylate, 2-ethylhexyl acrylate, and acrylic acid are dissolved in methylbenzene and ethyl acetate in the presence of BPO (the initiator), and the temperature is elevated to 80 degrees Celsius, so that the acrylic prepolymer is obtained by polymerization. A volume ratio of methylbenzene to total of butyl acrylate, 2-ethylhexyl acrylate, and acrylic acid is substantially 1.5:1. A volume of ethyl acetate is substantially equal to a total volume of butyl acrylate, 2-ethylhexyl acrylate, and acrylic acid.

Vinyl trimethoxy silane, ethyl alcohol, and BPO are added into the acrylic prepolymer, and the temperature is elevated at from about 70 degrees Celsius to 170 degrees Celsius, so that the acrylic polymer is obtained. A weight ratio of the vinyl trimethoxy silane to acrylic prepolymer is about 1:100. A weight ratio of BPO to acrylic prepolymer is about 0.2:100.

The highest heat resistance temperature of the pressure sensitive adhesive of EXAMPLE 2 is improved to be a range about 180 degrees Celsius to about 190 degrees Celsius. The heat tolerance time is improved to be a range about 24 hours to about 48 hours.

### Synthesis Example 3

Butyl acrylate, 2-ethylhexyl acrylate, and acrylic acid are dissolved in methylbenzene and ethyl acetate in the presence of BPO (the initiator), and the temperature is elevated to 80 degrees Celsius, so that the acrylic prepolymer is obtained by polymerization. A volume ratio of methylbenzene to total of butyl acrylate, 2-ethylhexyl acrylate, and acrylic acid is substantially 1.5:1.0. A volume of ethyl acetate is substantially equal to a total volume of butyl acrylate, 2-ethylhexyl acrylate, and acrylic acid.

Vinyl trimethoxy silane, ethyl alcohol, and BPO are added into the acrylic prepolymer, and the temperature is elevated at from about 70 degrees Celsius to 170 degrees Celsius, so that the acrylic polymer is obtained. A weight ratio of the vinyl trimethoxy silane to acrylic prepolymer is about 10:100. A weight ratio of BPO to acrylic prepolymer is about 0.2:100.

The highest heat resistance temperature of the pressure sensitive adhesive of EXAMPLE 3 is improved to be a range about 220 degrees Celsius to about 230 degree Celsius. The heat tolerance time is improved to be a range about 24 hours to about 48 hours.

Depending on the embodiment, some of the steps described above can be eliminated, while other additional steps can be added, and the sequence of steps can be changed. It is also to be understood that the description and the claims drawn to a method can include some indication in reference to certain steps. However, the indication used is only to be viewed for identification purposes and is not a suggestion as to an order for the steps.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A pressure sensitive adhesive, comprising:
an acrylic polymer, the acrylic polymer is obtained by polymerizing an acrylic prepolymer and one or more silane coupling agent, the acrylic polymer represented by the following formula: 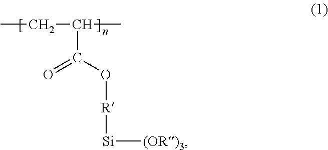
the acrylic prepolymer represented by the following formula: 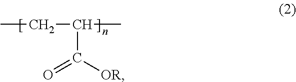
the one or more silane coupling agent represented by the following formula: 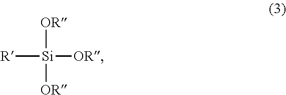
wherein n is an integer, R is hydrogen atom, alkyl group, or amino group, R′ is selected from the group consisting of vinyl group, epoxy group, methacrylic acid, amino group, thiol group, and isocyanic acid; and R″ is alkyl group or carboxylic group.

2. The pressure sensitive adhesive of claim 1, wherein the acrylic prepolymer is obtained by polymerizing butyl acrylate, 2-ethylhexyl acrylate, and acrylic acid; and the silane coupling agent is vinyl trimethoxy silane.

3. The pressure sensitive adhesive of claim 1, wherein a glass transition temperature of the acrylic prepolymer is in a temperature range of about minus 20 degrees Celsius to about minus 50 degrees Celsius.

4. A method of synthesizing an acrylic polymer used for a pressure sensitive adhesive, comprising steps as follows:
polymerizing at least one acrylic monomer in the presence of a first initiator to obtain an acrylic prepolymer; and
adding one or more silane coupling agent into the acrylic prepolymer in presence of a second initiator to obtain the acrylic polymer, wherein the acrylic polymer is represented by the following formula: 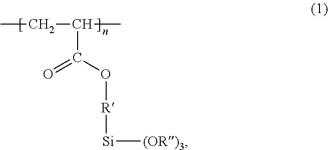
the acrylic prepolymer represented by the following formula: 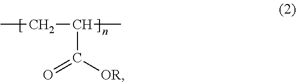
the silane coupling agent represented by the following formula: 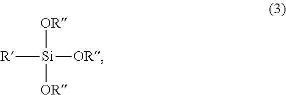
wherein n is an integer, R is hydrogen atom, alkyl group, or amino group, R′ is selected from the group consisting of vinyl group, epoxy group, methacrylic acid, amino group, thiol group, and isocyanic acid, and R″ is alkyl group or carboxylic group.

5. The method of synthesizing the acrylic polymer used for the pressure sensitive adhesive of claim 4, wherein the at least one acrylic monomer comprises butyl acrylate, 2-ethylhexyl acrylate, and acrylic acid; and the silane coupling agent comprises vinyl trimethoxy silane.

6. The method of synthesizing the acrylic polymer used for the pressure sensitive adhesive of claim 5, wherein a weight ratio of the silane coupling agent to the acrylic prepolymer is in a range of about 1:100 to about 10:100.

7. The method of synthesizing the acrylic polymer used for the pressure sensitive adhesive of claim 5, wherein a weight ratio of the silane coupling agent to the acrylic prepolymer is in a range of about 5:100 to about 10:100.

8. The method of synthesizing the acrylic polymer used for the pressure sensitive adhesive of claim 5, wherein an alcohol is further added into the acrylic prepolymer when adding the silane coupling agent into the acrylic prepolymer.

9. The method of synthesizing the acrylic polymer used for the pressure sensitive adhesive of claim 8, wherein a weight ratio of the alcohol to the acrylic prepolymer is in a range of about 5:100 to about 10:100.

10. The method of synthesizing the acrylic polymer used for the pressure sensitive adhesive of claim 4, wherein the second initiator comprises benzoyl peroxide, or 2,2′ azobisisobutyronitrile.
